(19) United States
(12) Patent Application Publication
(10) Pub. No.: US 2019/0152156 A1
(43) Pub. Date: May 23, 2019

(54) MAPPING RESOURCES

(71) Applicant: HEWLETT-PACKARD DEVELOPMENT COMPANY, L.P., Houston, TX (US)

(72) Inventors: Peter MOROVIC, Sant Cugat del Valles (ES); Jan MOROVIC, London (GB); Ingeborg TASTL, Palo Alto, CA (US); Melanie M. GOTTWALS, Palo Alto, CA (US); Andrew E. FITZHUGH, Palo Alto, CA (US); Gary J. DISPOTO, Palo Alto, CA (US); Lihua ZHAO, Palo Alto, CA (US)

(73) Assignee: Hewlett-Packard Development Company, L.P., Houston, TX (US)

(21) Appl. No.: 16/097,687

(22) PCT Filed: Jul. 21, 2016
(86) PCT No.: PCT/US2016/043351

§ 371 Date: Oct. 30, 2018

(51) Int. Cl. B29C 64/393; B33Y 50/02; G05B 19/4099

(52) U.S. Cl. CPC B29C 64/393; B29C 64/106; G05B 19/4099; B33Y 50/02

(57) ABSTRACT

In an example, a processing apparatus includes an interface to receive data representing a three-dimensional object. The data includes an object description comprising object property data. The processing apparatus comprises a mapping module to map the object description to an object generation description which includes at least one print material instruction associated with a predetermined combination of print materials from a set of print materials. The mapping module includes a plurality of mapping resources and each mapping resource associates combinations of print materials from the set of print materials with values of at least one object property. At least one object property of one mapping resource is different to at least one object property of another mapping resource. The processing apparatus also includes a selection module to select, for at least part of the object, one of the plurality of mapping resources to carry out mapping of the object description.

### BACKGROUND

Three-dimensional objects generated by an additive manufacturing process may be formed in a layer-by-layer manner. In one example of additive manufacturing, an object is generated by solidifying portions of layers of build material. In examples, the build material may be in the form of a powder, liquid, or sheet material. In some systems, the intended solidification and/or physical properties may be achieved by printing an agent onto a layer of the build material. Energy may be applied to the layer and the build material on which an agent has been applied may coalesce and solidify. In other examples, chemical binding agents may be used to bind a build material. In other examples, three-dimensional objects may be generated by using extruded plastics or sprayed materials as build materials, which solidify to form an object.

Some printing processes that generate three-dimensional objects use data generated from a model of a three-dimensional object. This data may, for example, specify the locations at which to apply an agent to the build material, or where a build material itself may be placed, and the amounts to be placed. The data may be generated from a three-dimensional representation of an object to be printed.

### BRIEF DESCRIPTION OF DRAWINGS

Non-limiting examples will now be described with reference to the accompanying drawings, in which:

FIG. 1 is a simplified schematic of an example of processing apparatus for mapping object descriptions to object generation descriptions;

FIG. 2 is a simplified schematic of another example of processing apparatus for mapping object descriptions to control data;

FIG. 3 is a flow chart of an example of a method for mapping object properties to print material specifications;

FIG. 4 is a flow chart of an example of a method for generating a three-dimensional object;

FIG. 5 is a flow chart of an example of a method for defining a mapping resource;

FIGS. 6A-6C show example modelled property gamuts;

FIG. 7 shows an example of how a property may change within a property gamut; and

FIG. 8 is a simplified schematic of an example processor and an example machine readable medium.

### DETAILED DESCRIPTION

Some examples described herein provide an apparatus and a method for processing data relating to a three-dimensional object and/or for generating data that may be used, for example by a three-dimensional printing system, or in an object generation apparatus, to produce a three-dimensional object. In some examples, data describing three-dimensional content with a variety of specified object properties is processed. These object properties may comprise appearance properties (color, transparency, glossiness, etc.), or functional properties (for example, conductivity, density, porosity, strength, etc.), and different object portions may comprise different object properties.

In some examples herein, a three-dimensional object is characterised in terms of ‘voxels’, i.e. three-dimensional pixels, wherein each voxel occupies or represents a discrete volume. In data modelling a three-dimensional object, a voxel at a given location may have at least one characteristic. For example, it may be empty, may have a particular color and/or may represent a particular material, or a particular object property, or the like. The voxels representing an object may have the same shape (for example, cubic or tetrahedral), or may differ in shape and/or size. A voxel may correspond to a region of a three-dimensional object which is individually addressable volume in additive manufacturing. In some examples in which the intended solidification and/or physical properties may be achieved by printing an agent onto a layer of the build material to form a slice of an object, a voxel size may be defined by the thickness of a layer of build material and the surface area of a layer which can individually be addressed with an agent. In some contexts, a voxel may be the resolution to which an object model, an object, or object generation data, is defined.

In some examples, a print material coverage representation defines print material data, for example detailing the amount of print materials (such as agent(s) to be deposited onto a layer of build material, or in some examples, build materials themselves), and, if applicable, their combinations. In some examples, this may be specified as a proportional volume coverage (for example, X % of a region of a layer of build material should have agent Y applied thereto). Such print materials may be related to or selected to provide at least one object property such as, for example, color, transparency, flexibility, elasticity, rigidity, surface roughness, porosity, conductivity, inter-layer strength, density, and the like.

The actual location at which each print material (for example, a drop of an agent) should be applied, as specified in control data, may be determined, for example, using halftoning techniques.

For example, a set of voxels within object model data may have an associated print material coverage representation comprising a set of print material volume coverage (Mvoc) vectors. In a simple case, such a vector may indicate that X % of a given region of a three-dimensional space should have a particular agent applied thereto, whereas (100−X) % should be left clear of any agent. This may define a probability distribution for a given material. In some examples, the material coverage representation may comprise a description of the coverage of a particular material. The print material coverage representation may then provide the input for a ‘halftoning’ process to generate control data that may be used by object generation apparatus to generate a three-dimensional object. For example, it may be determined that, to produce specified object properties, 25% of a layer of build material (or of a portion of a layer) should have an agent applied thereto. The halftoning process determines where the drops of agent fall in order to provide 25% coverage, for example by comparing each location to a threshold value provided in a halftone threshold matrix.

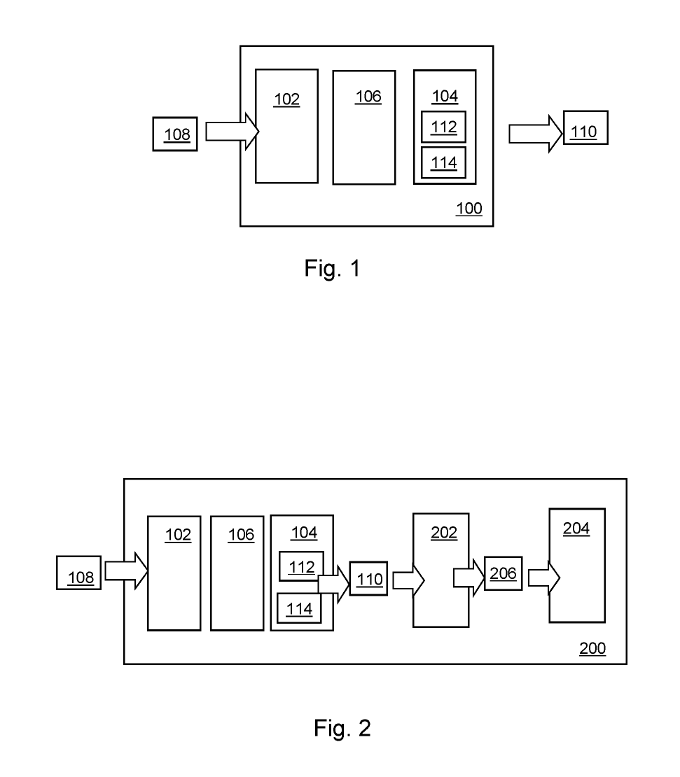

FIG. 1 is an example of processing apparatus 100 comprising an interface 102, a mapping module 104 and a selection module 106.

The interface 102 is adapted to receive data 108 representing a three-dimensional object. In some examples, the data 108 representing the three-dimensional object may comprise object model data defining a three-dimensional geometric model of at least a portion of an object, including the shape and extent of all or part of an object in a three-dimensional co-ordinate system, e.g. the solid portions of the object. The object model data may be generated by a computer aided design (CAD) application. In examples in which the object is represented in terms of voxels, given voxel may have associated data that indicates whether a portion of an object is present at that location.

In this example, the data 108 comprises an object description, the object description comprising object property data. The object property data may for example define at least one intended object property for the three-dimensional object to be generated. In one example, the object property data may comprise any or any combination of a specification of a color, flexibility, elasticity, rigidity, surface roughness, porosity, inter-layer strength, density, conductivity and the like for at least a portion of the object to be generated. This specification may be by way of at least one intended value for the property (for example a density of x grams per unit volume, or a color specified using values of a color space). The object property data may define multiple object properties for a portion or portions of an object. Object property data may comprise global and local object property data, e.g. certain object property values as defined in the object property data may be associated with each voxel that defines the object and/or certain object property values may be associated with a set of voxels, e.g. ranging from individual voxels to all voxels associated with the object. In one example, the data representing the three-dimensional object comprises a model of a three-dimensional object that has at least one object property specified at every location within the model, e.g. at every [x, y, z] co-ordinate, or for each voxel at which the object exists.

To consider an object in terms of voxels, one voxel of an object may be described as having a first property, for example a particular color, whereas another voxel may have no specified color but may instead have a specified strength. Another voxel may have a specified color and a strength, and so on. In another example, values for a set of properties may be given for each voxel of the object.

The mapping module 104 is adapted to map the received object description to an object generation description, the object generation description 110 comprising at least one print material instruction associated with a predetermined combination of print materials from a set of print materials. The object generation description 110 may be to control an object generation apparatus, or may be used to provide the basis of data to control an object generation apparatus.

The mapping module 104 comprises a plurality of mapping resources 112, 114, in this example a first mapping resource 112 and a second mapping resource 114. Each mapping resource 112, 114 associates combinations of build materials from the set of print materials with values of at least one object property, and at least one object property of one mapping resource 112, 114 is different to at least one object property of another mapping resource 112, 114. For example, the first mapping resource 112 may comprise, for each of a plurality of combinations of the set of print materials, an association with a first property (for example each combination may map to a value of the first property), and the second mapping resource 114 may comprise, for each of a plurality of combinations of the set of print materials, an association with a second property (which is different to the first property). In other examples, a mapping resource 112, 114 may relate combinations of the set of build materials to a plurality of object properties. Each mapping resource 112, 114 may map to an object property gamut, which may be a single dimensional gamut (i.e. a gamut of a single object property) or may be a multidimensional gamut (i.e. map to a gamut having axes relating to a plurality of object properties). In some examples, the combinations of the set of print materials having at least one associated property value in one mapping resource is different to the combinations of the set of print materials in at least one other mapping resource, although the set of print materials is common to both. In some examples, the set of print materials comprises print agents which are associated with the appearance of an object, such as an object's color and/or other appearance aspects. In some examples, the set of print agents is, or comprises, a set of colored agents. In some examples, the set of print agents is, or comprises, a set of colored agents and an energy absorption agent.

The mapping resources 112, 114 in some examples comprise look-up tables or the like. In such an example, the same set of print materials may be used to form two (or more) look-up tables. In some examples, at least some of the combinations of the set of print materials (which may for example comprise a set of print agents or of build materials) may be common to both look-up tables. In some examples, a mapping resource may comprise an association between a combination of the set of build materials and a plurality of properties. In some examples, the property or set of properties of the mapping resources are mutually exclusive in that, if a property is included in one mapping resource, it is not included in another. In some examples, there may be more than two mapping resources. In some examples, the mapping resources 112, 114 may effectively be provided in a single look-up table, with (for example) columns representing the different properties. It may be the case that not all combinations of print materials map to all columns. Selecting between mapping resources 112, 114 in such an example may comprise selecting a column, identifying a property value corresponding to the received object data in that column and determining a corresponding combination of print materials.

In some examples the object generation description 110 may comprise at least one volume coverage representation, for example at least one material volume coverage (Mvoc) vector. Each Mvoc may comprise a print material instruction. An Mvoc vector may have a plurality of values, wherein each value defines a proportion for each, or each combination of print materials in an addressable location of a layer of the three-dimensional object. For example, in an object generation apparatus with two available print materials (for example, agents)—M1 and M2, where each print material may be independently deposited in an addressable area of a layer of the three-dimensional object, there may be 2² (i.e. four) proportions in a given Mvoc vector: a first proportion for M1 without M2; a second proportion for M2 without M1; a third proportion for an over-deposit (i.e. a combination) of M1 and M2, e.g. M2 deposited over M1 or vice versa; and a fourth proportion for an absence of both M1 and M2. In this case an Mvoc vector may be: [M1, M2, M1M2, Z] or with example values [0.2, 0.2, 0.5, 0.1]—i.e. over a region of a z slice, 20% of [x, y] locations receive M1 without M2, 20% of [x, y] locations receive M2 without M1, 50% of [x, y] locations receive M1 and M2 and 10% are left empty. As each value is a proportion and the set of values represent the available print material combinations, the set of values in each vector sum to 1 or 100%.

For example, for colored agents, the Mvoc vector may be determined to select agent combinations that generate a match with a supplied object color description. As such, an Mvoc vector may be used as a print material instruction and may be used (directly or following processing, for example halftoning) to cause an object generation apparatus to generate the combination of voxels corresponding to the associated color description. However, as is further discussed below, while a particular combination of colored agents may provide a particular color (and in some examples, this may be their primary purpose), that particular combination may result in other properties, and these properties may differ for different combinations. To consider a simple example, a color which is created with a high amount of print agent—for example, the maximum number of drops of each available color—is likely to result in a region of the object which is denser (i.e. heavier per unit volume) than a color which is created using a low amount of print agent. However, other properties may also differ.

In a particular example, the first mapping resource 112 may be a color mapping resource (or relate to some other appearance aspect such as transparency or glossiness). Using this resource, the mapping module 104 may perform a mapping in which an input object description data 108, which may relate to a color of the object, for example in arbitrary XYZ color space (which may be a device independent color space or any color space such as those referred to as sRGB, CYMK, CIELab, or the like), maps to an object generation description 110, which may be an Mvoc, for example being stated in terms of a proportional combination of colored agents.

The second mapping resource 114 may map to a property other than color (or other than an appearance aspect). In some examples, the second mapping resource may be a ‘non-color’ or ‘non-appearance’ property mapping resource. For example the second mapping resource may characterise at least one functional property, for example conductivity, elasticity, strength, density, friction or the like. Such a mapping resource (which is termed a functional property mapping resource herein) is based on the same set of print materials as the first mapping resource 112. In this way, a single set of print materials may be more fully exploited for a wider range of properties. However, it may not be the case that each combination of print materials which may be applied by an object generation apparatus are represented in both (or indeed, either) mapping resource 112, 114. Some combinations may not be represented, for example as they do not contribute to the size of the gamut with respect to the property or group of properties under consideration (for example, resulting in a color or strength which may be achievable by another combination, for example using less material).

The selection module 106 is adapted to select, for at least part of the object, one of the mapping resources 112, 114 to carry out mapping of the received object description. In some examples, the interface 102 is to receive data comprising at least one indication of priority and the selection module 106 selects which of the mapping resources 112, 114 is selected based on the indication of priority. For example, all or part of an object may be associated with a specification of a priority. For example, such a priority may specify that, where color is stated, a color mapping resource is used, whereas where no color is stated, a resource associated with a different property may be used. Each included or anticipated property may be ranked in a priority order. In some examples, individual object portions, for example, voxels may be associated with priorities. In some examples, object portions may be characterised. For example, voxels which represent object regions which are to be on the surface (and in some examples, near the surface) of an object may have appearance properties prioritised, whereas ‘interior’ voxels may have other, for example, functional properties prioritised as the object portions represented thereby are unlikely to be seen and therefore the appearance thereof may be at most a secondary consideration, or not a consideration at all. Thus, in such an example, data describing object portions which are intended to be visible in a generated object may be automatically or manually associated with a first mapping resource, while data describing other object portions may be automatically or manually associated with a second mapping resource.

In some examples, the selection module 106 may be adapted to determine if data received by the interface comprises an instruction to select a particular stated mapping resource and, if so, to select the stated mapping resource and otherwise to select a default mapping resource. Such a determination may be global or may refer to a region (for example, a voxel). In other words, one of the mapping resources may comprise a default mapping resource, and the other mapping resource may be used in the event of positive selection thereof.

The input to the selection module 106 may be provided with, or as part of, other data relating to the object. In other examples, the input may be provided separately, for example being user specified at a point at which object generation is being considered.

FIG. 2 shows another example of a processing apparatus 200. In this example, in addition to the interface 102 and modules 104, 106 described in relation to FIG. 1, the processing apparatus 200 further comprises a control data module 202 and a print control module 204.

The control data module 202 is adapted to generate control data 206 to cause an object generation apparatus to generate an object having in at least a part thereof, an object property based on the object property data of the object description. This control data 206 may be used directly to control an object generation apparatus to generate an object. In some examples, generating control data may comprises applying halftoning to at least part of the object generation description 110. Halftoning may for example comprise comparing a value in a print material coverage representation with threshold values within a matrix to generate control data for generating a three-dimensional object based on the data 108 representing the object. The control data 206 may for example comprise a set of discrete print material choices for a pixel in a plane, wherein the discrete values across the area of the plane may be representative of proportions set out in a print material coverage representation.

The print control module 204 is adapted to control a three-dimensional object generation apparatus to generate a three-dimensional object according to the control data 206. In some examples, the processing apparatus 200 may be at least partially in, or in communication with, an object generation apparatus.

FIG. 3 is an example of a method, which may be implemented using at least one processor. Block 302 comprises receiving data representing a three-dimensional object. In an example, the data comprises an object description, the object description describing at least one object property.

Block 304 comprises identifying, for at least one object portion (which may be a voxel or defined in some other way), for that object portion, at least one object property to be provided in the object. For example, an object property may comprise at least one appearance property such as color or glossiness, or a functional property such as density, elasticity, break elongation, break strength, conductivity, or the like. In some examples, a number of object properties may comprise an object property ‘class’ and a single mapping resource may map to any property in the class. Each ‘class’ may comprise at least one category of property.

Block 306 comprises selecting, using at least one processor, and based on the determination, a mapping resource from a plurality of mapping sources, wherein the mapping resources associate a set of print materials with different object properties.

Block 308 comprises mapping the object description for at least a portion of the object to a print material specification for generating the object using the selected mapping resource.

Thus, according to the method of FIG. 3, two or more different mapping resources are based on the same set of print materials, and provide an association between that set of print materials and two different object properties or object property classes. The classes may be formed in any way. A selection is made between the mapping resources.

The method of FIG. 3 may be carried out iteratively for different object portions. In some examples, different mapping resources may be used for different portions of the same object (e.g. the method may comprises selecting, for a first object portion, a first mapping resource and, for a second object portion, a second mapping resource). These portions may for example be associated with data allowing a mapping resource to be selected. In some examples, this may be based on a categorisation of the portion (for example, if it is intended to be a visible portion or not), or a priority order for properties of a portion, or the like.

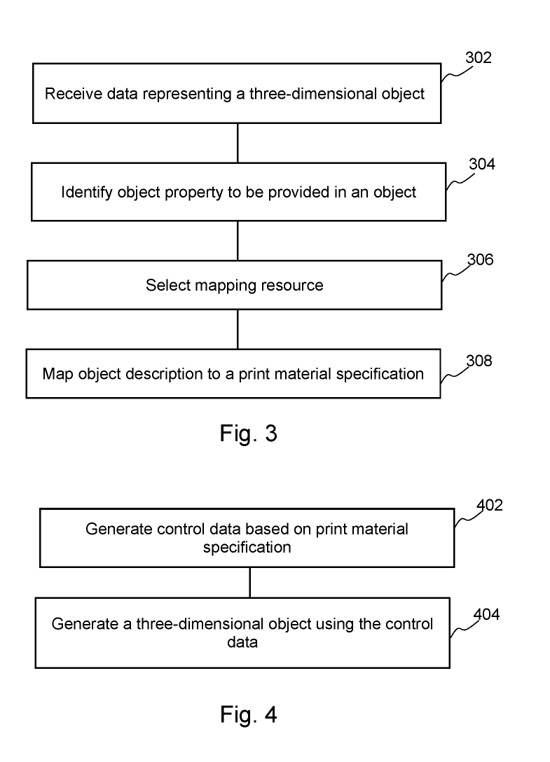

FIG. 4 shows another example of a method. In block 402, the print material specification of block 308 is used to generate control data. Block 404 comprises generating a three-dimensional object using the control data.

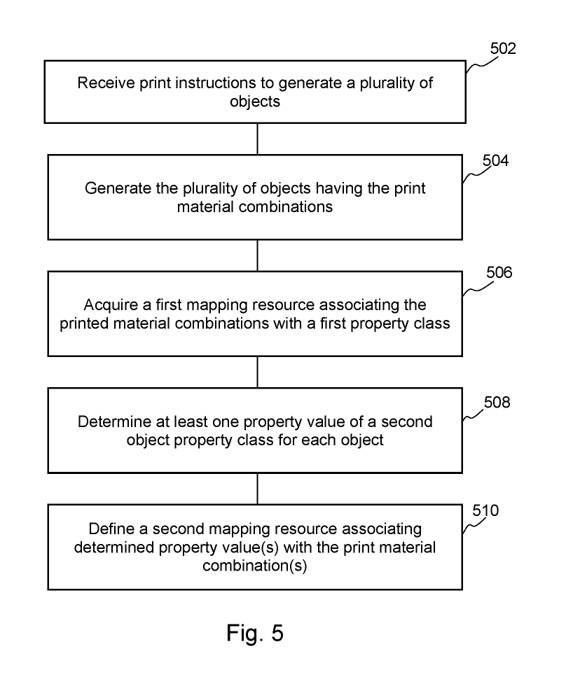

FIG. 5 is another example of a method, which may be a method of forming the mapping resources 112, 114. Block 502 comprises receiving print instructions to generate a plurality of objects, each object having a print material combination. For example, the materials may comprise build materials, print agents, or the like. In some examples, the material combinations may be for object generation by an object generation apparatus, which may be a particular object generation apparatus, or an apparatus in a particular state (for example, indicating if there are reserves of a particular print material). In some examples, an object generation apparatus may be at least one class or type of object generation apparatus. In some examples, the print material combinations may comprise anticipated materials or print material combinations, or anticipated common materials or print material combinations which may be available at any (e.g. an arbitrary) object generation apparatus. The same print material combination may be specified for the whole object (i.e. each object may be homogeneous). In some examples, the objects are generated to have the same size and shape, for example all being cubes of the same size.

In some examples, print material combinations may be selected with a view to characterising a gamut. As the term is used herein, ‘gamut’ may refer to the accessible range of property values or property combination values or parameters. For example, a color gamut may comprise the range of achievable colors for a particular object generation apparatus, while a strength gamut may comprise the range of available strengths. In some examples, various properties may be considered together. For example, various properties may relate to, or be associated with a common object property. For example, density (weight per unit volume), break strength, elongation and Young's modulus all relate to object strength, and could be used to form a four dimensional gamut. Therefore, in some examples, the selected properties may be related or associated with one another in the sense of being correlated with an underlying physical property. However, any single property or combination of properties may be selected as axes for a gamut, which could be single dimensional or multidimensional.

In some such examples, print material combinations may be selected for printing in object generation on a selective, and in some examples, iterative basis. In one example, the initial characterisation of a gamut of an object generation apparatus, which may be a particular object generation apparatus, or a class of apparatus, or the like. For example, combinations of print material which are anticipated or theorised to provide markedly different property parameters for a property of interest may be selected. For example, for color, this may be a set predicted to lie in the “hue ring” of a color gamut, i.e. the colors that at, each hue, have the highest chroma. Similarly, combinations which are likely to be the strongest and the weakest, or the most and least dense, or the like, could be selected. Based on measurements made, intermediate combinations may be tested (for example if the measured property does indeed turn out to be markedly different) or, if not, a different combination could be selected as a starting point for characterising a gamut.

Block 504 comprises generating the plurality of objects having the print material combinations. This may comprise generating using additive manufacturing, or 3D printing, apparatus.

Block 506 comprises acquiring a first mapping resource associating the print material combinations with a first property class. In some examples, this may be an association between the print material combinations and the values of the property or properties of the first property class. In some examples, this may be predetermined, for example having previously been characterised. In other examples, this may be determined via measurement. Where the first mapping resource relates to color values, this may for example be colorimetric measurement, of the generated objects. Determining the first mapping resource may comprise any of the techniques discussed in relation to the second mapping resource below, but relating to a different property or set of properties.

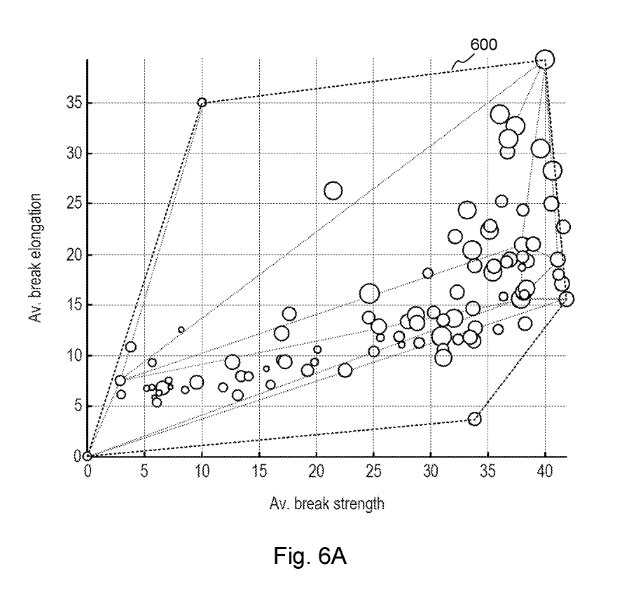

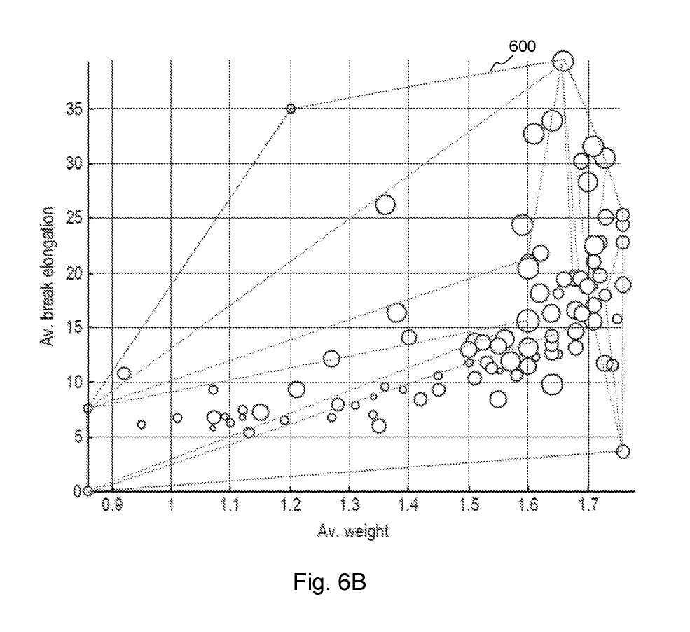

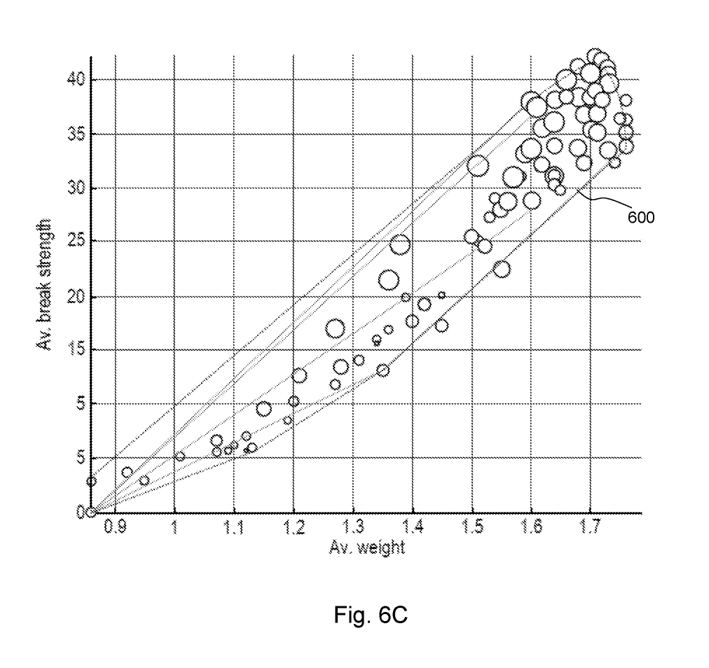

Block 508 comprises determining at least one property value of each object. For example, such a property value may be determined by measurement of the property (for example, determining a color, weighing the object, stretching or compressing the object until it breaks, passing a known current therethrough or the like). The determined property value is a value of a property of a second object property class. Block 510 comprises defining a second mapping resource, the second mapping resource associating least one determined property value of an object with the print material combination of that object. As is now described in greater detail with reference to FIG. 6, defining the second mapping resource may comprise determining a convex gamut for the second object property class, the convex gamut having a number of dimensions corresponding to the number of properties in the second object property class. The second mapping resource may comprise a look-up table generated from the convex gamut.

The print material combinations for those combinations of voxels which contribute the size of the gamut may be selected for inclusion in a mapping resource. The other combinations may be regarded as being interior to the convex hull of the gamut, i.e. they do not provide additional property value choices, and, in some examples, may therefore be discarded.

For example, as noted above, there may be cases where there is a plurality of print material combination which result in a similar properties, for example, similar colorimetries. However, one such combination may be associated with a set of functional properties which, for example, is more likely to be useful in object generation (or, if a specific object is being considered, is more suited to that particular object). In some examples, some or all combinations may be maintained in a mapping resource, and may for example be selected between at the point of object generation. Thus, in one example a particular mapping resource may be influenced by, or comprise as a secondary indicator, a property from another mapping resource. However, the selection of the mapping from the particular color resource is dictated principally with a view to the principle property mapped thereto. If for example the principle property of a first mapping resource was color, and the principle property of a second mapping resource was a functional property, the selection from each is led by the principle property, with any other property being a subsidiary, or incidental, aspect.

In some examples, the mapping resources may be distinct in the sense that the properties are evaluated entirely independently. In other examples, the print material combination associated with particular object properties, which may for example be properties which are considered favourable in three-dimensional object generation, or in generation of at least one particular object, are included in the mapping resource while other print material combinations are discarded.

In some examples, a selection may be made between print material combinations which result in a similar properties on an arbitrary basis. In some examples, print material combinations which use more, or more expensive, printing resources (for example, more print agent, or those which are associated with a higher energy use) may be discounted. Some print material combinations may be discounted as falling outside thresholds for a property. Other parameters, or combinations of parameters, could be used for selection.

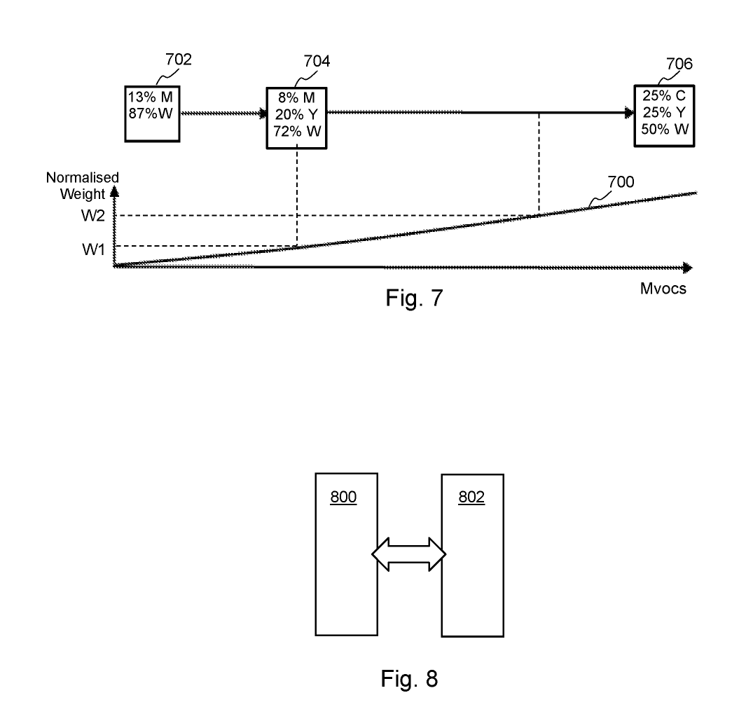

As is described in relation to FIGS. 6A-6C and FIG. 7, in some examples, a gamut may be substantially characterised by testing, which may allow explicit mappings to be determined. In some examples, implicit mappings may be determined through interpolation.

FIG. 6A-6C show an example in which a set of objects are generated using combinations of four print agents: CMY+NIRD (cyan, magenta, yellow and near-infrared-absorbing dye) agents and a common plastic powder build material. In this example, agent placement is binary (i.e. either agent is deposited at a print voxel or it is not). In this example, the set of objects each being generated based on a single Mvoc, the Mvocs being a representative set of the available ones to the system (i.e., representative of all volume coverage weighted combinations of the apparatus' material vectors, which are its possible print resolution voxel contents). This may comprise initially building Mvocs over the existing set of material vectors, or Mvecs (being the full set of possible “at voxel” states). In the absence of other control mechanisms, for this example, a single build material and four agents used in a binary fashion, this amounts to 16 Mvecs, 4 with one agent applied, 6 with two agents applied, 4 with three agents applied, one with none and one with all four agents applied) by varying their volume coverages (i.e. combining each with the ‘empty’ Mvec that represents not placing any material at a voxel) as well as combining them among themselves.

The result is a set of N physical, generated (printed) objects that represent a sampling of the Mvoc domain. Each of the N objects is evaluated in terms of a property or set of functional properties that are of interest.

For the sake of example, in this case, a set of properties comprises weight (where, as in this example, each object has the same volume this can be considered “normalized” and equivalent to density), break strength and break elongation, although other properties or combinations of properties could be considered.

Each of these properties is considered as an axis in a domain having a dimension in relation to each property. This domain is the theoretical space of varying (in this example, functional) properties. The measurements/evaluations of each of the N objects will delimit a sub-space of this domain, which is the property gamut (in this example, the Weight-Strength-Elongation, or WSE, gamut).

FIG. 6A shows the determined (for example, measured) values of the property break strength against the values for break elongation for each of a number of combinations of print materials. In the Figure, each circle marker represents a print material combination with the size of the circle being indicative of the volume of print agent applied (larger circles indicating more drops of print material per unit volume than a smaller circle). FIG. 6B shows similar data, but in this example the determined property values are for weight vs break elongation, and FIG. 6C shows the determined property values for weight vs break strength with samples plotted in.

As noted above, the size of the circular markers indicate volume coverage of the respective Mvecs (here Mvecs were used individually, although combinations thereof could also be considered), with their size indicating the volume of print agent applied and the hull 600 indicates a convex estimate of the functional property gamut. Here 12 Mvocs were combined with the blank Mvec at varying volume coverage resulting in 96 samples (some of which are obscured by others).

This indicates the available ranges and sub-spaces of the full domain that are accessible to the object generation by means of controlling the Mvecs and their volume coverages.

From this gamut, a [properties→Mvoc] look-up table can be built which in this case takes the form of [Weight value, Break Strength value, Break Elongation value→Mvoc]. For example, the data set of 96 data points may be tessellated resulting in an N-vertex look-up table. In this case, intermediate values may be derived or interpolated. In some examples, a convex hull may be built based on the samples (i.e. the ‘outer markers’ of the gamut are preserved and the inner markers are discarded), and used to form a look-up table. In this example this would result in a 24 entry look-up table.

Maintaining all the data points may reduce reliance on interpolation and benefits more from the individual data points, but is more susceptible to noise than the reduced set and may result in non-smooth transitioning when applied. A reduced look-up table provides access to the whole gamut but has fewer defined points and thus interpolation may be utilised to obtained intended object properties (for example, this may be a tetrahedral interpolation), but may provide smoother transitioning in the respective property domain. To make it more robust it is possible to smooth the gamut by locally averaging Mvocs that result in similar functional properties.

Once a look-up table has been developed, it may be applied in the same manner as any other mapping table. A contone description (of as many dimensions as the look-up table gives access to, in this example, three in this case) indicates the intended property value. Intermediate values may be derived by interpolation, or by a proportional combination of the MVocs marking the extremes of the axis of that property. Such a look-up table may be used as a mapping resource as described in relation to any of FIG. 1-5.

FIG. 7 shows an example which the line 700 traces weight values within a functional gamut. In this example, this property is fairly well correlated to elongation but this need not be the case, and the properties of a gamut may be unrelated or ‘decorrelated’ such that their values can be independently embodied in a generated object. In order to access the range of values, three Mvocs 702, 704, 706 may be combined in varying proportions. These are from lightest Mvoc 702, which is magenta (with 13% of locations receiving a drop of magenta agent and 87% being left clear or White) through a Magenta and Yellow Mvoc 704 (a combination specifying that 8% of locations receive a drop of magenta agent, 20% of locations receive a drop of yellow agent and 72% are left clear or White) and the heaviest Mvoc 706 on the right, using Cyan and Yellow at a high volume coverage (specifying that 25% of locations receive a drop of cyan agent, 25% of locations receive a drop of yellow agent and 50% are left clear or White).

It may be noted that, while the combinations of print agents produce colors, it is not color that is controlled using the look-up table developed in this example. Instead, weight change and elongation change are controlled and the resulting color is determined accordingly. An intended value of weight or density would lead to a selection of an Mvoc, or to defining a combination of defined Mvocs.

For example, if a normalised weight W1 was specified for object generation, this may in turn lead to the specification of Mvoc 704 for generating that object or object portion. This Mvoc, when used to manufacture a test object, resulted in a normalised weight of W1. If Weight W2 was specified, an Mvoc could be interpolated as being a combination of Mvocs 704 and 706. In the example of the Figures, Mvoc 706 may be more heavily weighted in the combination than Mvoc 704, as the specified weight is closer to the weight produced by the heavier Mvoc 706. Thus, in the combination, the heavier Mvoc 706 may be given, for example, 3 times the weighting of Mvoc 704, leading to the specification of an Mvoc [2% M, 18.75%, C 23.75% Y, 55.5% W].

As briefly mentioned above, once an initial characterisation of the gamut exists, a refined sampling of print material combinations may be determined and used to carry out linearization and calibration of the gamut.

A priority may be assigned to the axes to resolve conflicts between object properties (for example, a weight and an elongation which cannot both be achieved by any combination for MVocs).

An object generated using such a look-up table may vary in all other aspects not controlled thereby—i.e. it may vary in color, surface finish, roughness, elasticity, conductivity etc., since none of these are directly controlled by the look-up table. As noted above, for this reason, in some examples a color or appearance based look-up table could be used to map the surface or near surface voxels, i.e. those voxels which correspond to object portions which, once the object is generated, are visible (or more generally, any visible object portion) and at least one ‘functional’ properties look-up table could be used to map the interior voxels, i.e. those voxels which correspond to object portions which, once the object is generated, are interior to the object and/or not visible from the outside of the object (or more generally, any interior object portion).

While the description here considers a system aimed at providing color variety in three-dimensional object generation and using it to control functional properties, it may be applied in other contexts to increase control over different properties, which may not be the principle property or properties for which the agent is provided.

FIG. 8 shows a processor 800 associated with a computer readable medium, in this example a memory 802. The memory 802 is for storing data for access by an application program executed by the processor 800. The memory 802 may store data, for example a mapping resource 112, 114, or may store instructions for execution by the processor 800. In such an example, the instructions may be to cause the processor to carry out any of the blocks of the flow charts herein, or to provide a module 104, 106, 202, 204 of a processing apparatus.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus (such as the processing apparatus 100, 200, or a module 104, 106, 202, 204 thereof or the processor 800 mentioned above) may execute the machine readable instructions. Thus the interface 102 and functional modules 104, 106, 202, 204 of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage (for example a memory 802 as described above) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices may realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Processing apparatus comprising:
an interface to receive data representing a three-dimensional object, the data comprising an object description, the object description comprising object property data;
a mapping module to map the object description to an object generation description, the object generation description comprising at least one print material instruction associated with a predetermined combination of print materials from a set of print materials, wherein the mapping module comprises a plurality of mapping resources, each mapping resource associating combinations of print materials from the set of print materials with values of at least one object property, wherein at least one object property of one mapping resource is different to at least one object property of another mapping resource; and
a selection module to select, for at least part of the object, one of the plurality of mapping resources to carry out mapping of the object description.

2. Processing apparatus according to claim 1 further comprising a control data module, the control data module being to generate control data to cause an object generation apparatus to generate an object having, in at least a part thereof, an object property based on the object property data of the object description.

3. Processing apparatus according to claim 2 further comprising a print control module, the print control module being to control a three-dimensional object generation apparatus to generate a three-dimensional object according to the control data.

4. Processing apparatus according to claim 1 in which at least one mapping resource is a color mapping resource associating at least one color in an object description with at least one print material combination.

5. Processing apparatus according to claim 1 in which at least one mapping resource is a functional property mapping resource associating values of at least one functional property in an object description with print material combinations.

6. Processing apparatus according to claim 1 in which the interface is to receive data comprising at least one indication of priority and the selection module to select which mapping resource is selected based on the indication of priority.

7. Processing apparatus according to claim 1 in which the selection module is to determine if data received by the interface comprises an instruction to select a stated mapping resource and, if so, to select the stated mapping resource and otherwise to select a default mapping resource.

8. A method comprising:
receiving, at at least one processor, data representing a three-dimensional object, the data comprising an object description, the object description comprising at least one object property;
identifying, using at least one processor, for at least one object portion, at least one object property to be provided in the object;
selecting, using at least one processor, a mapping resource from a plurality of mapping sources, wherein the mapping resources associate a predetermined set of print materials with different object properties, and wherein the selected mapping resource associates the predetermined set of print materials with the identified at least one object property; and
mapping the object description for at least a portion of the object to a print material specification for generating the object using the selected mapping resource.

9. The method of claim 8 further comprising generating control data based on the print material specification.

10. The method of claim 9 further comprising generating a three-dimensional object using the control data.

11. The method of claim 9 further comprising selecting, for a first object portion, a first mapping resource and, for a second object portion, a second mapping resource.

12. The method of claim 11 in which the first mapping resource is selected for a visible object portion and the second mapping resource is selected for an interior object portion.

13. A method comprising:
receiving print instructions to generate a plurality of objects, each object having a print material combination;
generating the plurality of objects having the print material combinations;
acquiring a first mapping resource associating the print material combinations with a first object property class;
determining at least one property value of a second object property class of each object; and
defining a second mapping resource, the second mapping resource associating at least one determined property value of an object with the print material combination of that object.

14. A method according to claim 13 wherein defining the second mapping resource comprises determining a convex gamut for the second object property class, the convex gamut having a number of dimensions corresponding to a number of properties in the second object property class.

15. A method according to claim 14 wherein defining the second mapping resource comprises determining a look-up table from the convex gamut.
